(19) United States
(12) Patent Application Publication
(10) Pub. No.: US 2010/0195736 A1
(43) Pub. Date: Aug. 5, 2010

(54) MOVING IMAGE DECODER, MOVING IMAGE DECODING METHOD, AND COMPUTER-READABLE MEDIUM STORING MOVING IMAGE DECODING PROGRAM

(75) Inventor: Miki Haseyama, Sapporo-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: NATIONAL UNIVERSITY CORP HOKKAIDO UNIVERSITY, Sapporo-shi (JP)

(21) Appl. No.: 12/757,749

(22) Filed: Apr. 9, 2010

Related U.S. Application Data
(63) Continuation of application No. PCT/JP08/68393, filed on Oct. 9, 2008.

(30) Foreign Application Priority Data
Oct. 9, 2007 (JP) 2007-263721

(51) Int. Cl. H04N 7/12

(52) U.S. Cl. 375/240.16; 375/E07.027

(57) ABSTRACT

Matching processing reconstructs divided lost regions, which are obtained by dividing a lost region in an image of a Frame t into regions each including N×N pixels as a unit, from corresponding regions of an estimated image of a previously reconstructed Frame t−1 using a boundary matching method. Estimation pre-processing calculates local regions of the estimated image of Frame t−1, which correspond to local regions of each divided lost region in the image of Frame t using a block matching method, and calculates second motion vectors for respective pixels from local regions associated with region in the image of Frame t−1 for all pixels L×L included in each local region of divided lost region. Original image estimation processing defines a transition model and observation model from the result obtained by the estimation pre-processing, and estimates an original image using a Kalman filter algorithm.

### CROSS-REFERENCE TO RELATED APPLICATIONS

This is a Continuation Application of PCT Application No. PCT/JP2008/068393, filed Oct. 9, 2008, which was published under PCT Article 21 (2) in Japanese.

This application is based upon and claims the benefit of priority from prior Japanese Patent Application No. 2007-263721, filed Oct. 9, 2007, the entire contents of which are incorporated herein by reference.

### BACKGROUND OF THE INVENTION

1. Field of the Invention

The present invention relates to a moving image decoder which decodes a moving image signal encoded for respective frames, a moving image decoding method, and a computer-readable medium storing a moving image decoding program and, more particularly, to decoding processing executed when an error region or lost region is generated in a decoded image.

2. Description of the Related Art

A moving image encoded for respective frames is normally decoded using motion vectors and motion-compensated prediction errors. However, with this method, when a received signal fails to be correctly decoded, data of motion vectors and motion-compensated prediction errors are lost, thus consequently generating distortions and lost regions caused by errors (to be correctly referred to as a lost region hereinafter) in a decoded image.

As means for solving this problem, a method which estimates motion vectors of a lost region from those of a neighboring region of the lost region and interpolates pixel values from a previous frame has been proposed (for example, see reference 1 [M. Ghanbari and V. Seferidis, “Cell loss concealment in ATM video codecs,” IEEE Trans. Circuit System Video Technol., vol. 3, pp. 238-247, June 1993]). However, with this method, when the neighboring region of the lost region cannot be used, it is difficult to restore data. Also, in case of a frame including a moving object, since the re-estimated motion vectors have low precision, high-precision restoration cannot be attained.

On the other hand, a method of interpolating pixel values of a lost region on a spatial domain using information only in the same frame as that including the lost region has been proposed. As such method, a method of interpolating to minimize boundary errors using surrounding pixels (for example, see reference 2 [S. S. Hemami and T. H. Y. Meng, “Transform coded image reconstruction exploiting interblock correlations,” IEEE Trans. Image Processing, vol. 4, pp. 1023-1027, July 1995]) and a method using edge information of surrounding pixels (for example, see reference 3 [H. Sun and W. Kwok, “Concealment of damaged block transform coded images using projection onto convex sets,” IEEE Trans. Image Processing, vol. 4, pp. 470-477, April 1995]) have been proposed. However, these methods cannot attain high-precision restoration since they do not Use any inter-frame correlations to estimate pixel values of a lost region.

Hence, as a method using inter-frame correlations, a boundary matching algorithm has been proposed. With this method, motion vectors of a lost region are estimated from a region in which pixel values are given and which exists in the neighborhood of the lost region, and the lost region is interpolated by pixel values of a region of the previous frame associated by the estimated motion vectors (for example, see reference 4 [W. M. Lam, A. R. Reibman and B. Liu, “Recovery of lost or erroneously received motion vectors,” ‘Proc. ICASSP 1993, vol. 5, pp. 417-420]) However, this boundary matching algorithm poses another problem that errors propagate to subsequent frames to be restored since it does not consider any errors generated upon interpolating the lost region by the pixel values of the corresponding region of the previous frame.

### BRIEF SUMMARY OF THE INVENTION

As described above, in the conventional moving image decoder, when data of motion vectors and motion-compensated prediction errors are lost, the method of interpolating pixel values from the previous frame by estimating motion vectors of a lost region, the method of interpolating pixel values of a lost region on a spatial domain, and the method of interpolating pixel values of a lost region from the previous frame using the boundary matching algorithm are carried out, but it is difficult for these methods to maintain high-precision restoration.

It is an object of the present invention to provide a moving image decoder which can restore a lost region with high precision even when data of motion vectors and motion-predicted prediction errors are lost, a moving image decoding method, and a computer-readable medium storing a moving image decoding program.

According to first embodiment of the invention, there is provided a moving image decoder, which receives a moving image signal which is compressed and encoded by prediction between frames which are motion-compensated for respective blocks each including M×M (M is a natural number greater than or equal to 2) pixels, and decodes an original moving image signal by sequentially repeating processing for detecting motion vectors for respective blocks from an image of a first frame in the moving image signal, calculating motion-compensated prediction values corresponding to the motion vectors detected from the image of the first frame, and generating an image of a second frame which follows the first frame from the motion vectors and the motion-compensated prediction values, the decoder comprising: a matching processing unit configured to detect a defective region Ψ which suffers a loss or an error from the image of the second frame, to divide defective region Ψ into a plurality of regions ωₜ each including N×N (N≦M) pixels as a unit, to estimate first motion vectors (d=(dₓ, d_{y})) of the plurality of obtained divided defective regions ωₜ, to estimate a plurality of regions ωₜ₋₁ in the image of the first frame, which correspond to the plurality of divided defective regions ωₜ in the image of the second frame, based on the first motion vectors, and to interpolate the plurality of divided defective regions ωₜ in the image of the second frame by pixel values of the plurality of estimated regions ωₜ₋₁ in the image of the first frame; a pre-processing unit configured to calculate second motion vectors (v=(vₓ, v_{y})) of small defective regions γₜ each of which has each of the N×N pixels (x, y) as the center and includes L×L (L≦N) pixels in each divided defective region ωₜ of N×N pixels in the image of the second frame, to estimate a plurality of small regions γₜ₋₁ each including L×L pixels in the image of the first frame, which respectively correspond to the plurality of small defective regions γₜ in the image of the second frame, based on the second motion vectors, and to calculate a matrix A_{x,y} (t) used to estimate pixel values X_{x,y}(t) of original images of the plurality of small defective regions γₜ in the image of the second frame from pixel values X_{x+vx, y+vy}(t−1) of the plurality of small estimated regions γₜ₋₁ in the image of the first frame; and an estimation unit configured to estimate pixel values X_{x,y}(t) of the original image of each small defective region γₜ by estimating a covariance matrix Qᵥ(t) of an error vector, which is expressed by Z_{x,y}(t)−H_{x,y}(t)X_{x,y}(t), using a matrix H_{x,y}(t) which gives pixel values Z_{x,y}(t) of an observation image from pixel values X_{x,y}(t) of each small defective region γₜ including the L×L pixels.

According to second embodiment of the invention, there is a moving image decoding method, which receives a moving image signal which is compressed and encoded by prediction between frames which are motion-compensated for respective blocks each including M×M (M is a natural number greater than or equal to 2) pixels, and decodes an original moving image signal by sequentially repeating processing for detecting motion vectors for respective blocks from an image of a first frame in the moving image signal, and generating an image of a second frame which follows the first frame from motion-compensated prediction values corresponding to the motion vectors detected from the image of the first frame, the method comprising: executing matching processing for detecting a defective region which suffers a loss or an error from the image of the second frame, dividing defective region Ψ into a plurality of regions ωₜ each including N×N (N≦M) pixels as a unit, estimating first motion vectors (d (dₓ, d_{y})) of the plurality of obtained divided defective regions ωₜ, estimating a plurality of regions ωₜ₋₁ in the image of the first frame, which correspond to the plurality of divided defective regions ωₜ in the image of the second frame, based on the first motion vectors, and interpolating the plurality of divided defective regions ωₜ in the image of the second frame by pixel values of the plurality of estimated regions ωₜ₋₁ in the image of the first frame; executing pre-processing for calculating second motion vectors (v=(vₓ, v_{y})) of small defective regions γₜ each of which has each of the N×N pixels (x, y) as the center and includes L×L (L≦N) pixels in each divided defective region ωₜ of N×N pixels in the image of the second frame, estimating a plurality of small regions γₜ₋₁ each including L×L pixels in the image of the first frame, which respectively correspond to the plurality of small defective regions γₜ in the image of the second frame, based on the second motion vectors, and calculating a matrix A_{x,y}(t) used to estimate pixel values X_{x,y}(t) of original images of the plurality of small defective regions γₜ in the image of the second frame from pixel values X_{x+vx,y+vy}(t−1) of the plurality of small estimated regions γₜ₋₁ in the image of the first frame; and executing estimation processing for estimating pixel values X_{x,y}(t) of the original image of each small defective region γₜ by estimating a covariance matrix Qᵥ(t) of an error vector, which is expressed by Z_{x,y}(t)−H_{x,y}(t)X_{x,y}(t), using a matrix H_{x,y}(t) which gives pixel values Z_{x,y}(t) of an observation image from pixel values X_{x,y}(t) of each small defective region γₜ including the L×L pixels.

According to third embodiment of the invention, there is a computer-readable medium storing a moving image decoding program that makes a computer execute moving image decoding processing, which receives a moving image signal which is compressed and encoded by prediction between frames which are motion-compensated for respective blocks each including M×M (M is a natural number greater than or equal to 2) pixels, and decodes an original moving image signal by sequentially repeating processing for detecting motion vectors for respective blocks from an image of a first frame in the moving image signal, and generating an image of a second frame which follows the first frame from motion-compensated prediction values corresponding to the motion vectors detected from the image of the first frame, the program making the computer execute: matching processing for detecting a defective region Ψ which suffers a loss or an error from the image of the second frame, dividing defective region into a plurality of regions ωₜ each including N×N (N≦M) pixels as a unit, estimating first motion vectors (d=(dₓ, d_{y})) of the plurality of obtained divided defective regions ωₜ, estimating a plurality of regions ωₜ₋₁ in the image of the first frame, which correspond to the plurality of divided defective regions ωₜ in the image of the second frame, based on the first motion vectors, and interpolating the plurality of divided defective regions ωₜ in the image of the second frame by pixel values of the plurality of estimated regions ωₜ₋₁ in the image of the first frame; pre-processing for calculating second motion vectors (v=(vₓ, v_{y})) of small defective regions γₜ each of which has each of the N×N pixels (x, y) as the center and includes L×L (L≦N) pixels in each divided defective region ωₜ of N×N pixels in the image of the second frame, estimating a plurality of small regions γₜ₋₁ each including L×L pixels in the image of the first frame, which respectively correspond to the plurality of small defective regions γₜ in the image of the second frame, based on the second motion vectors, and calculating a matrix A_{x,y}(t) used to estimate pixel values X_{x,y}(t) of original images of the plurality of small defective regions γₜ in the image of the second frame from pixel values X_{x+vx,y+vy}(t−1) of the plurality of small estimated regions γₜ₋₁ in the image of the first frame; and estimation processing for estimating pixel values X_{x,y}(t) of the original image of each small defective region γₜ by estimating a covariance matrix Qᵥ(t) of an error vector, which is expressed by Z_{x,y}(t)−H_{x,y}(t)X_{x,y}(t), using a matrix H_{x,y}(t) which gives pixel values Z_{x,y}(t) of an observation image from pixel values X_{x,y}(t) of each small defective region γₜ including the L×L pixels.

### BRIEF DESCRIPTION OF THE SEVERAL VIEWS OF THE DRAWING

FIG. 1 is a block diagram showing the basic arrangement of a moving image decoder including error concealment processing as a characteristic feature of the present invention as an embodiment of the present invention;

FIG. 2 is a flowchart showing the processing sequence of the error concealment processing included in an inter-frame prediction decoding unit shown in FIG. 1;

FIG. 3 is a conceptual view for explaining a practical method for estimating a region ωₜ₋₁ in an image of a Frame t−1, which corresponds to a divided lost region ωₜ of N×N pixels in an image of a Frame t in matching process S1 shown in FIG. 2;

FIG. 4 is a conceptual view for explaining a practical method for calculating a motion vector v=(vₓ, v_{y}) for a local region γₜ of L×L pixels in the image of Frame t in estimation pre-process S2 shown in FIG. 2;

FIG. 5 is a flowchart showing the sequence of Kalman filter algorithm processing for a local region γₜ of L×L pixels in the image of Frame t in original image estimation process S3 shown in FIG. 2;

FIG. 6 is a graph showing PSNR characteristics obtained upon decoding an image using only a conventional BMA method and those obtained using a decoding algorithm according to the embodiment of the present invention in comparison with each other;

FIG. 7A is a view showing an original image used to explain the decoding algorithm of the embodiment and the conventional BMA method in comparison with each other in terms of effects in an actual decoded image;

FIG. 7B is a view showing a non-corrected transmitted image used to explain the decoding algorithm of the embodiment and the conventional BMA method in comparison with each other in terms of effects in an actual decoded image;

FIG. 8A is a view showing a decoded image obtained by correcting the non-corrected image shown in FIG. 7B using the decoding algorithm of the embodiment;

FIG. 8B is a view showing a decoded image obtained by correcting the non-corrected image shown in FIG. 7B using the conventional BMA method;

FIG. 9 is a view showing differences of pixel values between the decoded image by the embodiment shown in FIG. 8A and that by the conventional method shown in FIG. 8B;

FIG. 10A is an enlarged view of a portion where differences of pixel values between the images shown in FIG. 9 are large in the decoded image by the embodiment shown in FIG. 8A; and

FIG. 10B is an enlarged view of a portion where differences of pixel values between the images shown in FIG. 9 are large in the decoded image by the conventional method shown in FIG. 8B.

### DETAILED DESCRIPTION OF THE INVENTION

Embodiments of the present invention will be described hereinafter with reference to the drawings. Note that the interpolation sequence of a lost region according to the present invention when an encoded sequence of a received moving image includes errors and a lost portion is generated in a decoded image will be described in detail below with reference to the drawings.

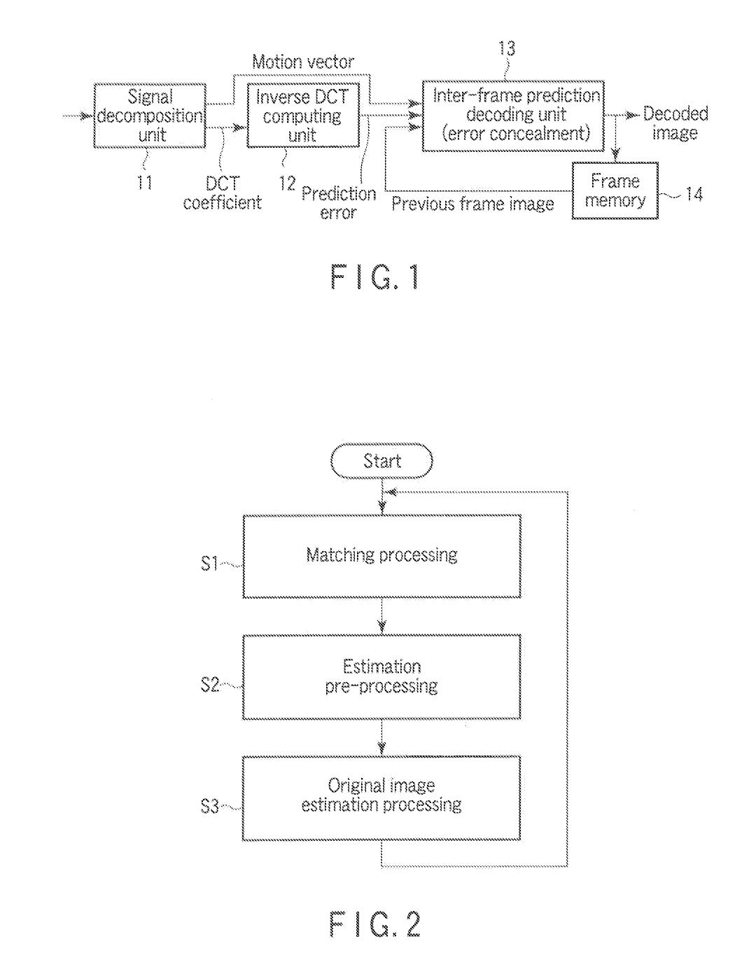

FIG. 1 is a block diagram showing the basic arrangement of a moving image decoder including error concealment processing as a characteristic feature of the present invention as an embodiment of the present invention. Referring to FIG. 1, a signal decomposition unit 11 receives a moving image signal, which is compressed and encoded by prediction between motion-compensated frames for respective blocks each including M×M pixels (M is a natural number greater than or equal to 2) and is demodulated by a receiving unit (not shown), and decomposes this moving image signal into motion vectors and discrete cosine transform (DOT) coefficients. Of the motion vectors and DOT coefficients, the DCT coefficients are supplied to an inverse DCT computing unit 12. This inverse DCT computing unit 12 calculates prediction errors by computing inverse DCTs of the input DCT coefficients. The prediction errors are supplied to an inter-frame prediction decoding unit 13 together with the motion vectors.

This inter-frame prediction decoding unit 13 fetches a previous frame image stored in a frame memory 14, and decodes a next frame image using the previous frame image, and the newly input motion vectors and prediction errors. Then, the inter-frame prediction decoding unit 13 executes matching process S1, estimation pre-process S2, and original image estimation process S3 shown in FIG. 2 in turn as error concealment processing, thus restoring a lost region.

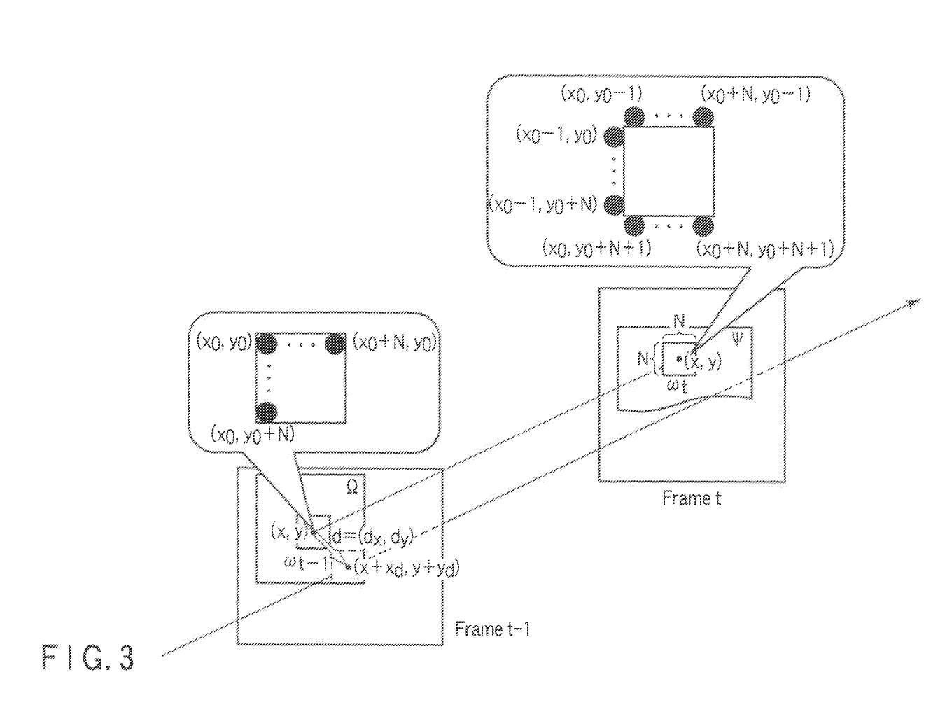

The sequence of the error concealment processing of the inter-frame prediction decoding unit 13 will be described below with reference to FIGS. 3 to 5.

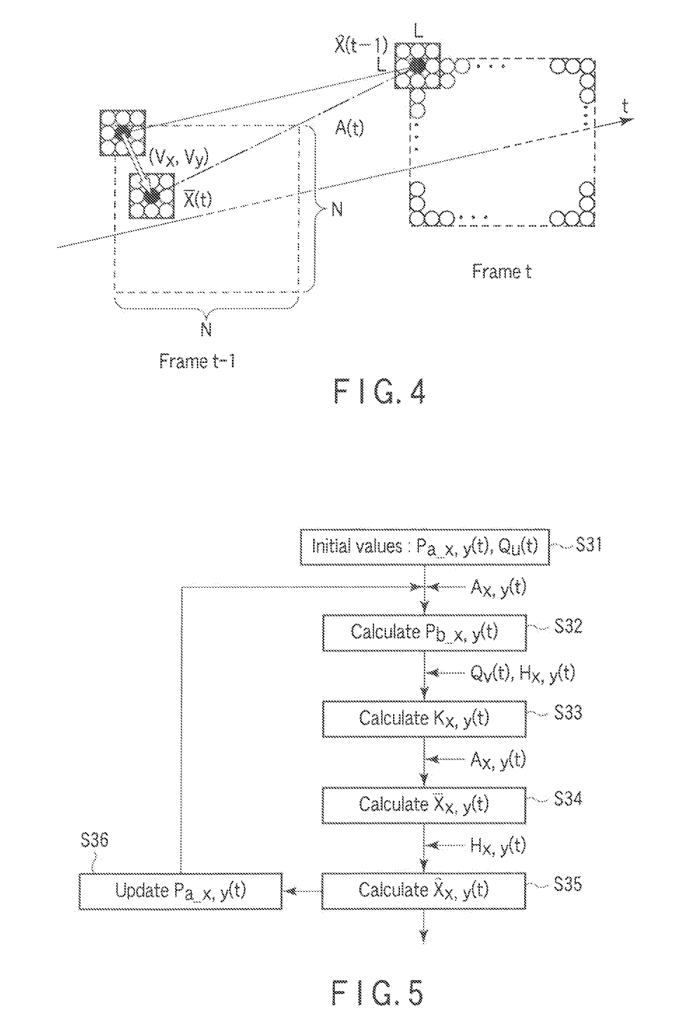

FIG. 3 is a conceptual view showing the state of the matching process S1 shown in FIG. 2, FIG. 4 is a conceptual view showing the state of the estimation pre-process S2 shown in FIG. 2, and FIG. 5 is a flowchart showing the sequence of Kalman filter processing as an example of the estimation process shown in FIG. 2. Note that a moving image frame at time t is expressed as a Frame t, and a moving image frame at time t−1 one frame before is expressed as a Frame t−1 for the sake of simplicity.

In the matching process S1, as shown in FIG. 3, divided lost regions ωₜ, which are obtained by dividing a lost region Ψ of an image of Frame t into regions each including N×N pixels (N≦M), are reconstructed from corresponding regions ωₜ₋₁ of an estimated image of the previously restored Frame t−1, using a boundary matching algorithm.

Next, in the estimation pre-process S2, as shown in FIG. 4, local regions γₜ₋₁ of the estimated image of Frame t−1, which correspond to local regions γₜ of each divided lost regions ωₜ in the image of Frame t, are calculated using a block matching method. Then, second motion vectors v=(vₓ, v_{y}) for respective pixels are calculated from local regions γₜ₋₁ associated with region ωₜ₋₁ in the image of Frame t−1 for all pixels L×L in a small block smaller than a block of N×N pixels included in each local region γₜ of each divided lost region ωₜ.

Finally, in the original image estimation process S3, a transition model and observation model are defined based on the result obtained by the estimation pre-process S2, and an original image is estimated using a Kalman filter algorithm shown in FIG. 5. This Kalman filter algorithm is a method for estimating an image for respective blocks (each including N×N pixels in this case) using a state transition model which expresses changes between an image at the previous time and that at the next time using motion vectors, and an observation model which expresses correspondence between an original image and observation image using an observation matrix. Note that details of the Kalman filter algorithm are introduced in New Edition “Applied Kalman Filter”, Toru Katayama, Jan. 20, 2000, Asakura Publishing.

The contents of the processing executed in aforementioned processes S1 to S3 will be described in more detail below.

[Matching Process S1]

In the matching process S1, letting fₜ(x, y) be a pixel value of a pixel (x, y) in each divided lost region ωₜ, first motion vectors (d=(dₓ, d_{y})) of that divided lost region ωₜ are estimated as shown below. Note that the boundary matching algorithm is used in this case. However, other methods that estimate pixel values by estimating motion vectors from the previous frame may be used.

Let ωₜ₋₁ be a divided estimated region of N×N pixels in the image of Frame t−1, which corresponds to the same position as that of each divided lost region ωₜ of N×N pixels obtained by dividing lost region Ψ in the image of Frame t, and Ω be a neighboring region including divided estimated region ωₜ₋₁. Then, it is estimated that divided lost region ωₜ in the image of Frame t is included in this region Ω.

Note that let (x₀, y₀) be the position of a pixel at the upper left end in each of regions ωₜ and ωₜ₋₁, (x₀+N, y₀) be the upper right end, and (x₀, y₀+N) be the lower left end. Then, let C_{A} be a variance value between pixel values fₜ₋₁(x, y₀) (x₀≦x≦x₀+N−1) of pixels on the top side of divided estimated region ωₜ₋₁ and pixel values fₜ(x, y₀−1) (x₀≦x≦x₀+N−1) of pixels above by one pixel the top side of divided lost region ωₜ, C_{L} be a variance value between pixel values fₜ₋₁(x₀, y) (y₀≦y≦y₀+N−1) of pixels on pixel values fₜ(x₀−1, y) (y₀≦y≦y₀+N−1) of pixels on the left side by one pixel of the left side of ωₜ, and C_{B} be a variance value between pixel values fₜ₋₁(x, y₀+N−1) (x₀≦x≦x₀+N−1) of pixels on the bottom side of divided estimated region ωₜ₋₁ and pixel values fₜ(x, y₀+N) (x₀≦x≦x₀+N−1) of pixels below by one pixel the bottom side of divided lost region ωₜ. Then, the variance values C_{A}, C_{L}, and C_{B} can be calculated as follows:

$$\begin{matrix}[ Mathematical 1 ] & \\ {C}_{A} = {\sum }_{x = {x}_{0}}^{{x}_{0} + N - 1} {( {f}_{t - 1} ( x , {y}_{0} ) - {f}_{t} ( x , {y}_{0} - 1 ) )}^{2} & ( 1 ) \\ {C}_{L} = {\sum }_{x = {y}_{0}}^{{y}_{0} + N - 1} {( {f}_{t - 1} ( {x}_{0} , y ) - {f}_{t} ( {x}_{0} - 1 , y ) )}^{2} & ( 2 ) \\ {C}_{B} = {\sum }_{x = {x}_{0}}^{{x}_{0} + N - 1} {( {f}_{t - 1} ( x , {y}_{0} + N - 1 ) - {f}_{t} ( x , {y}_{0} + N ) )}^{2} & ( 3 )\end{matrix}$$

The position of the pixel (x, y) is sequentially moved in the neighboring region Ω, the variance values C_{A}, C_{L}, and C_{B} are calculated for respective pixels (x, y), and the first motion vector d=(dₓ, d_{y}) is estimated from a position (x+dₓ, y+d_{y}) where a total variance value C=C_{A}+C_{L}+C_{B} becomes smallest. Then, divided lost region ωₜ is interpolated by pixel values of a region of N×N pixels having the position (x+dₓ, y+d_{y}) as the center.

[Estimation Pre-Process S2]

In the estimation pre-process S2, as shown in FIG. 4, in the image of Frame t, which is restored by the matching process S1, a local region Ωₜ of L×L pixels (L≦N) having each of the N×N pixels interpolated to divided lost region wt as the center is formed, and block matching is performed for each local region γₜ. Then, motion vectors v=(vₓ, v_{y}) of local region γₜ and a local region γₜ₋₁ on Frame t−1 corresponding to local region γₜ on Frame t are calculated.

Next, correspondence between pixels of these two local regions γₜ and γₜ₋₁ is calculated to estimate pixel values X_{x,y}(t) in the image of target Frame t from pixel values X_{x+vx,y+vy}(t−1) in the image of Frame t−1. In this process, an element in the k-th row and 1st column in a matrix A_{x,y}(t) used to estimate pixel values X_{x,y}(t) of the original image of each local region γₜ in the image of Frame t assumes “1” when the k-th element of X_{x,y}(t) corresponds to the 1st element of X_{x+vx,y+vy} (t−1); otherwise, it assumes “0”.

[Original Image Estimation Process S3]

Letting X_{x,y}(t) and Z_{x,y}(t) be pixel values in local regions γₜ extracted from the original image and observation image, the state transition model and observation model are respectively expressed by:

### [Mathematical 2]

[State Transition Model]

X_{x,y}(t)=A_{x,y}(t)X_{x+vx,y+vy}(t−1)+U(t) (4)

[Observation Model]

Z_{x,y}(t)=H_{x,y}(t)X_{x,y}(t)+V(t) (5)

where X_{x,y}(t) and Z_{x,y}(t) are vectors obtained by raster-scanning pixel values in local regions γt (L×L pixels) having pixels (x, y) in the original image and observation image as the centers.

Furthermore, other matrices and vectors are defined as follows:
A_{x,y}(t): a matrix in which elements assume “0” or “1”, and which is used to estimate pixel values X_{x,y}(t) in local region γₜ in the image of Frame t from pixel values X_{x+vx,y+vy}(t−1) in local region γₜ₋₁ in the image of Frame t−1 associated by the motion vectors (vₓ, v_{y}).
U(t): an error vector which expresses X_{x,y}(t)−A_{x,y}(t)X_{x+vx,y+vy}(t−1).
Hx,_{y}(t): a matrix which gives the observation image from the original image.
V(t): an error vector which expresses Z_{x,y}(t)−H_{x,y}(t)X_{x,y}(t).

When the state transition model and observation models are defined, as described above, the Kalman filter algorithm is expressed by:

### [Mathematical 3]

P_{b}_{_{—}}_{x,y}(t)=A_{x,y}(n)Pₐ_{_{—}}_{x,y}(t−1)A_{x,y}^{T}(t)+Q_{U}(t) (6)

K_{x,y}(t)=P_{b}_{_{—}}_{x,y}(t)H_{x,y}^{T}(t)[H_{x,y}(t)P_{b}_{_{—}}_{x,y}(t)H_{x,y}^{T}(t)+Q_{V}(t)]⁻¹ (7)

X̅_{x,y}(t)=A_{x,y}(t)\hat{X}_{x,y}(t−1) (8)

\hat{X}_{x,y}(t)= X̅_{x,y}(t)+K_{x,y}(t)[Z_{x,y}(t)−H_{x,y}(t) X̅_{x,y}(t)] (9)

Pₐ_{_{—}}_{x,y}(t)=P_{b}_{_{—}}_{x,y}(t)−K_{x,y}(t)H_{x,y}(t)P_{b} _{_{—}}_{x,y}(t) (10)

where P_{b}_{_{—}}_{x,y}(t) and Pₐ_{_{—}}_{x,y}(t) are covariance matrices of estimation errors which are respectively given by:

### [Mathematical 4]

P_{b}_{_{—}}_{x,y}(t)=E[(X_{x,y}(t)− X̅_{x,y}(t))(X_{x,y}(t)− X̅_{x,y}(t)^{T}] (11)

Pₐ_{_{—}}_{x,y}(t)=E[(X_{x,y}(t)−\hat{X}_{x,y}(t))(X_{x,y}(t)−\hat{X}_{x,y}(t))^{T}] (12)

where Q_{U}(t) and Q_{V}(t) are diagonal matrices including an average 0 and variances σᵤ² and σᵥ² as diagonal elements.

When an observation image Z_{x,y}(t) includes a lost region; all elements in rows corresponding to the lost region in the observation matrix H_{x,y}(t) become zero. As a result, elements of rows in K_{x,y}(t) corresponding to these rows become zero, and cannot be corrected. As one method to solve this problem, a result obtained by reconstructing the lost region by a convex projection method is used as the observation image Z_{x,y}(t). That is, an image obtained by processing the entire frame by low-pass filter processing may be used intact, but when an image further reconstructed by the convex projection method is used, estimation with higher precision can be attained. However, the present invention is not limited to such specific method. As other methods, for example, intra-frame interpolation may be used.

More specifically, a result obtained by restoring the lost region using the boundary matching algorithm for the purpose of motion vector compensation in the matching process S1 is used as an initial value, and pixel values X_{x,y}(t) of the original image in small defective region γₜ are estimated, using the convex projection method, from an image which is given with the low-pass filter characteristics by the observation matrix. A result which is converged by the convex projection method under the following two constraint conditions is used as the reconstruction result.

(1) Given pixel values in an image to be reconstructed are values of the original image, and remain unchanged.

(2) Low-frequency components in a frequency domain remain unchanged, and high-frequency components become zero.

In this manner, pixel values of a region where the lost region exists in the observation image reconstructed by the convex projection method are pixel values of the original image which are degraded by the low-pass filter processing and on which noise components are superposed. Hence, the observation matrix H_{x,y}(t) can be defined by approximating a low-pass filter using a matrix, and includes coefficients of the low-pass filter in respective rows.

Assuming that each element of a vector W(t) including observation noise as elements corresponds to white noise according to N(0, σᵥ²), σᵥ² can be calculated as a difference between pixel value Z_{x,y}(t) of the reconstruction result by the convex projection method, and the product of pixel value X_{x,y}(t) of the original image and H_{x,y}(t), i.e., by W_{x,y}=Z_{x,y}(t)−H_{x,y}(t)X_{x,y}(t) (Equation (5)). Thus, an estimated current image \hat{X}_{x,y}(t) in a small region of L×L pixels can be derived from Equations (6) to (12).

The Kalman filter algorithm applies this processing to all N×N pixels while shifting the center pixel (x, y) one by one, and further applies similar processing to all regions of N×N pixels in an error region and lost region in the image of Frame t. More specifically, as shown in FIG. 5, Pₐ_{_{—}}_{x,y}(t) and Q_{U}(t) are set as initial values (step S31), and P_{b}_{_{—}}_{x,y}(t) is calculated using the matrix A_{x,y}(t) (step S32). Next, K_{x,y}(t) is calculated using Qᵥ(t) and H_{x,y}(t) (step S33), X̅_{x,y}(t) is calculated using A_{x,y}(t) again (step S34), and the estimated current image \hat{X}_{x,y}(t) is calculated using H_{x,y}(t) again (step S35). Subsequently, Pₐ_{_{—}}_{x, y}(t) is updated using this estimated current image \hat{X}_{x,y}(t) (step S36), and the above processes from step S32 are repetitively executed.

By executing aforementioned processes S1 to S3, errors and losses can be restored with high precision.

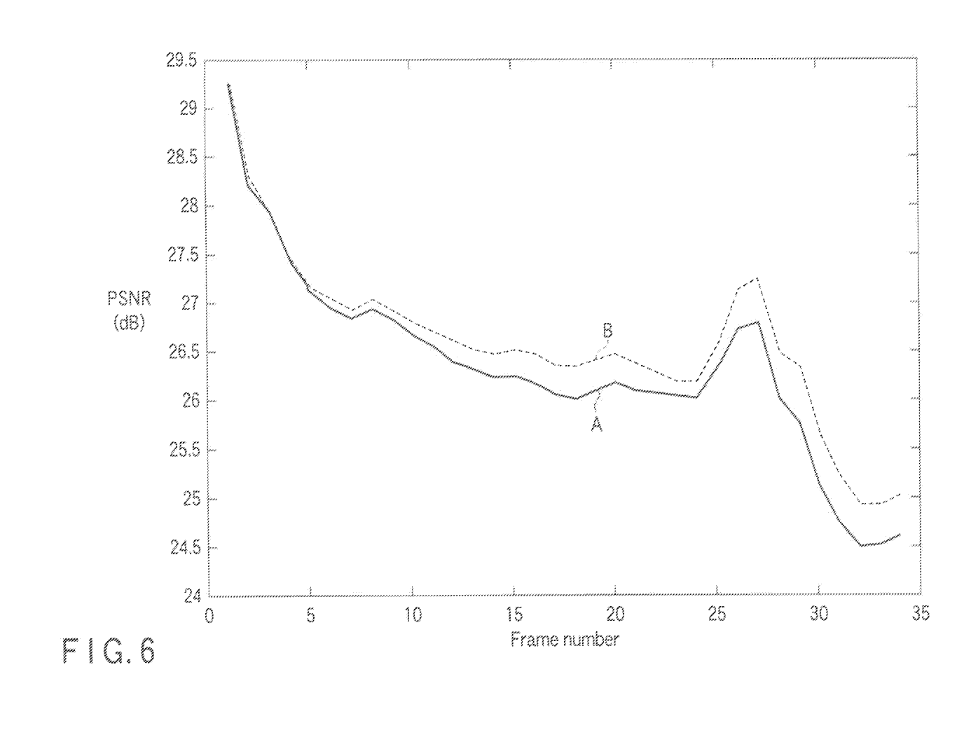

In order to present the effects of the present invention, FIG. 6 shows simulation characteristics (peak signal-to-noise ratio [PSNR]) characteristics) A obtained upon decoding using only the boundary matching algorithm (BMA) as one of the conventional methods, and simulation characteristics B upon using the decoding algorithm by means of aforementioned processes S1 to S3 in comparison with each other. In this case, divided lost region ωₜ of N×N pixels is set to be the same as a macroblock (16×16 pixels) prevalently used in a general image encoding method, local region γₜ of L×L pixels is defined by 3×3 pixels, σᵤ²=0.5, and σᵥ²=10. Also, pixel values Z_{x,y}(t) of the observation image in local region γₜ are estimated using the convex projection method. As can be seen from FIG. 6, the decoding algorithm of the present invention can assure characteristic improvement by a maximum of about 0.5 dB compared to the conventional method.

Furthermore, the effects in an actual decoded image will be explained by comparing the decoding algorithm of the embodiment and the conventional BMA method.

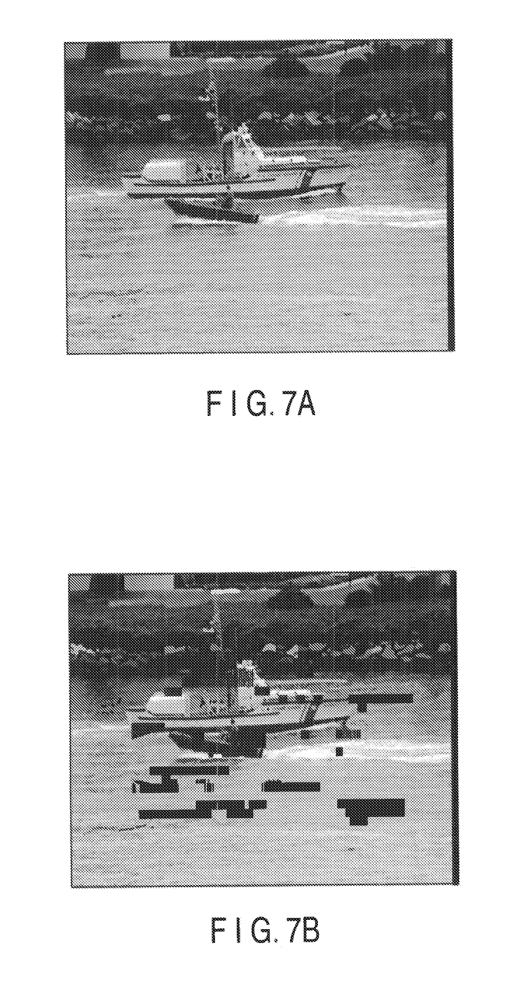

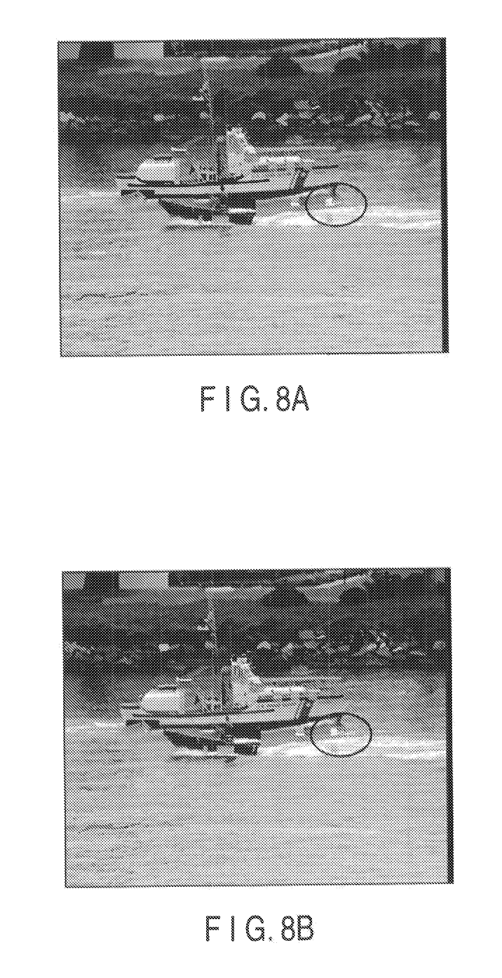

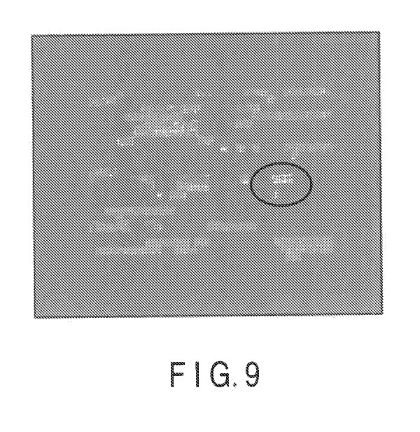

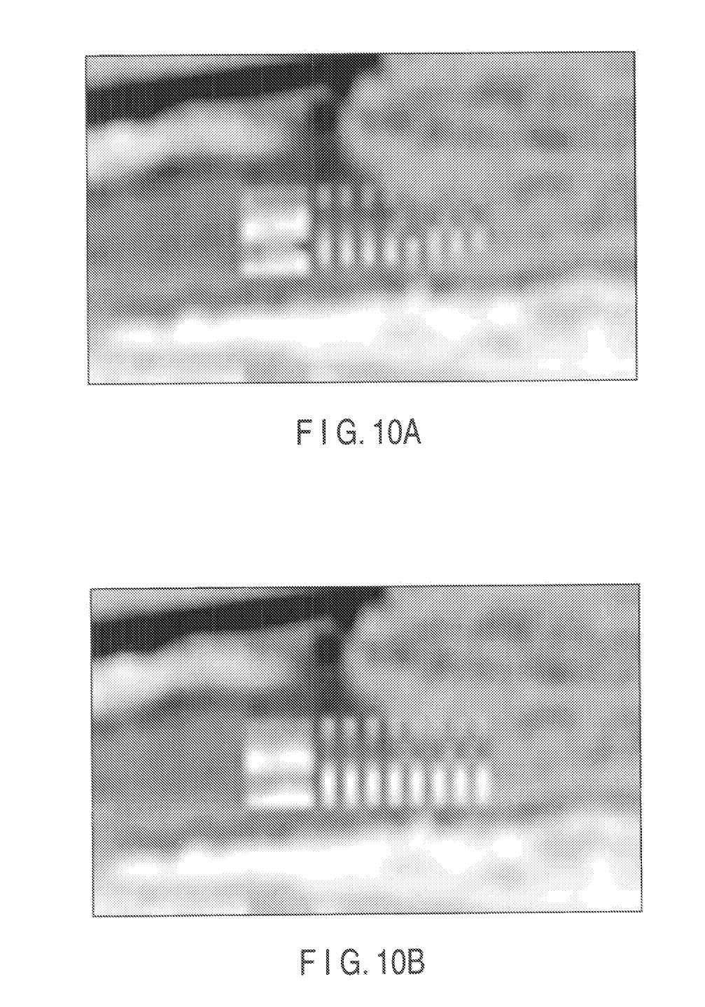

Assume that as a result of transmission of an original image (free from any error) shown in FIG. 7A, an image in which lost regions are generated due to, e.g., transmission path errors, is obtained, as shown in FIG. 7B. When this image is corrected using the decoding algorithm of the embodiment, an image shown in FIG. 8A is obtained. When the image is corrected using the conventional BMA method, an image shown in FIG. 8B is obtained. Upon calculating differences between pixel values so as to clarify their difference in terms of effects, an image shown in FIG. 9 is obtained. Upon scaling up a portion having a particularly large difference, an image shown in FIG. 10A is obtained in case of the decoding algorithm according to the present invention, and an image shown in FIG. 10B is obtained in case of the conventional BMA method. Hence, as can be seen from FIG. 10A, regions that can be rescued are broadened.

Therefore, according to the moving image decoder with the above arrangement, even when data of motion vectors and motion-compensated prediction errors are lost, the lost region can be restored from an image of the previous frame with very high precision. In addition, since errors generated upon interpolating the lost region by pixel values of the corresponding region in the previous frame are taken into consideration, errors can be prevented from propagating to subsequent frames to be restored. Hence, high-precision restoration can be continuously executed.

Note that the present invention is not limited to the above embodiment intact, and can be embodied by modifying required constituent elements without departing from the scope of the invention when it is practiced. For example, the case has been explained wherein the original image estimation process S3 of the embodiment uses the Kalman filter algorithm. However, the present invention is not limited to such specific algorithm. As other methods, for example, a recursive least squares (RLS) algorithm, and extended Kalman filter algorithm may be used.

By appropriately combining a plurality of required constituent elements disclosed in the embodiment, various inventions can be formed. For example, some of all the required constituent elements disclosed in the embodiment may be deleted. Furthermore, required constituent elements in different embodiments may be appropriately combined.

The present invention is especially suitably used in a moving image decoder included in a mobile phone, image processing terminal, and the like, each of which receives and decodes a compression-encoded moving image which is transmitted wirelessly.

What is claimed is:

1. A moving image decoder, which receives a moving image signal which is compressed and encoded by prediction between frames which are motion-compensated for respective blocks each including M×M (M is a natural number greater than or equal to 2) pixels, and decodes an original moving image signal by sequentially repeating processing for detecting motion vectors for respective blocks from an image of a first frame in the moving image signal, calculating motion-compensated prediction values corresponding to the motion vectors detected from the image of the first frame, and generating an image of a second frame which follows the first frame from the motion vectors and the motion-compensated prediction values, the decoder comprising:
a matching processing unit configured to detect a defective region Ψ which suffers a loss or an error from the image of the second frame, to divide defective region Ψ into a plurality of regions ωₜ each including N×N (N≦M) pixels as a unit, to estimate first motion vectors (d=(dₓ, d_{y})) of the plurality of obtained divided defective regions ωₜ, to estimate a plurality of regions ωₜ₋₁ in the image of the first frame, which correspond to the plurality of divided defective regions ωₜ in the image of the second frame, based on the first motion vectors, and to interpolate the plurality of divided defective regions ωₜ in the image of the second frame by pixel values of the plurality of estimated regions ωₜ₋₁ in the image of the first frame;
a pre-processing unit configured to calculate second motion vectors (v=(vₓ, v_{y})) of small defective regions γₜ each of which has each of the N×N pixels (x, y) as the center and includes L×L (L≦N) pixels in each divided defective region γₜ of N×N pixels in the image of the second frame, to estimate a plurality of small regions γₜ₋₁ each including L×L pixels in the image of the first frame, which respectively correspond to the plurality of small defective regions γₜ in the image of the second frame, based on the second motion vectors, and to calculate a matrix A_{x,y}(t) used to estimate pixel values X_{x,y}(t) of original images of the plurality of small defective regions γₜ in the image of the second frame from pixel values X_{x+vx,y+vy}(t−1) of the plurality of small estimated regions γₜ₋₁ in the image of the first frame; and
an estimation unit configured to estimate pixel values X_{x,y}(t) of the original image of each small defective region γₜ by estimating a covariance matrix Qᵥ(t) of an error vector, which is expressed by Z_{x,y}(t)−H_{x,y}(t)X_{x,y}(t), using a matrix H_{x,y}(t) which gives pixel values Z_{x,y}(t) of an observation image from pixel values X_{x,y}(t) of each small defective region γₜ including the L×L pixels.

2. The moving image decoder according to claim 1, wherein the estimation unit estimates pixel values X_{x,y} (t) of the original image of small defective region γₜ using a state transition model that expresses changes between an image at a previous time and an image at a next time using motion vectors and an observation model that expresses correspondence between the original image and the observation image using an observation matrix, and using a Kalman filter algorithm that estimates an image for N×N pixels as a unit.

3. The moving image decoder according to claim 2, wherein the estimation unit compensates for the motion vectors of the state transition model when a loss for respective blocks is generated.

4. The moving image decoder according to claim 3, wherein the estimation unit uses a boundary matching algorithm in compensation of the motion vectors.

5. The moving image decoder according to claim 2, wherein the estimation unit uses low-pass filter characteristics in the observation matrix of the observation model.

6. The moving image decoder according to claim 5, wherein the estimation unit estimates, using a convex projection method, pixel values X_{x,y}(t) of the original image of small defective region γₜ from an image given with the low-pass filter characteristics by the observation matrix.

7. The moving image decoder according to claim 1, wherein the pre-processing unit calculates the second motion vectors (v=(vₓ, v_{y})) using a block matching method.

8. The moving image decoder according to claim 1, wherein the pre-processing unit estimates pixel values Z_{x,y}(t) of the observation image of small defective region γₜ of the L×L pixels using a convex projection method.

9. A moving image decoding method, which receives a moving image signal which is compressed and encoded by prediction between frames which are motion-compensated for respective blocks each including M×M (M is a natural number greater than or equal to 2) pixels, and decodes an original moving image signal by sequentially repeating processing for detecting motion vectors for respective blocks from an image of a first frame in the moving image signal, and generating an image of a second frame which follows the first frame from motion-compensated prediction values corresponding to the motion vectors detected from the image of the first frame, the method comprising:
executing matching processing for detecting a defective region Ψ which suffers a loss or an error from the image of the second frame, dividing defective region Ψ into a plurality of regions ωₜ each including N×N (N≦M) pixels as a unit, estimating first motion vectors (d=(dₓ, d_{y})) of the plurality of obtained divided defective regions ωₜ, estimating a plurality of regions ωₜ₋₁ in the image of the first frame, which correspond to the plurality of divided defective regions ωₜ in the image of the second frame, based on the first motion vectors, and interpolating the plurality of divided defective regions ωₜ in the image of the second frame by pixel values of the plurality of estimated regions ωₜ₋₁ in the image of the first frame;
executing pre-processing for calculating second motion vectors (v=(vₓ, v_{y})) of small defective regions γₜ each of which has each of the N×N pixels (x, y) as the center and includes L×L (L≦N) pixels in each divided defective region ωₜ of N×N pixels in the image of the second frame, estimating a plurality of small regions γₜ₋₁ each including L×L pixels in the image of the first frame, which respectively correspond to the plurality of small defective regions γₜ in the image of the second frame, based on the second motion vectors, and calculating a matrix A_{x,y}(t) used to estimate pixel values X_{x,y}(t) of original images of the plurality of small defective regions γₜ in the image of the second frame from pixel values X_{x+vx,y+vy}(t−1) of the plurality of small estimated regions γₜ₋₁ in the image of the first frame; and
executing estimation processing for estimating pixel values X_{x,y}(t) of the original image of each small defective region γₜ by estimating a covariance matrix Qᵥ(t) of an error vector, which is expressed by Z_{x,y}(t)−H_{x,y}(t)X_{x,y}(t), using a matrix H_{x,y}(t) which gives pixel values Z_{x,y}(t) of an observation image from pixel values X_{x,y}(t) of each small defective region γₜ including the L×L pixels.

10. The moving image decoding method according to claim 9, wherein the estimation processing estimates pixel values X_{x,y}(t) of the original image of small defective region γₜ using a state transition model that expresses changes between an image at a previous time and an image at a next time using motion vectors and an observation model that expresses correspondence between the original image and the observation image using an observation matrix, and using a Kalman filter algorithm that estimates an image for N×N pixels as a unit.

11. The moving image decoding method according to claim 10, wherein the estimation processing compensates for the motion vectors of the state transition model when a loss for respective blocks is generated.

12. The moving image decoding method according to claim 11, wherein the estimation processing uses a boundary matching algorithm in compensation of the motion vectors.

13. The moving image decoding method according to claim 10, wherein the estimation processing uses low-pass filter characteristics in the observation matrix of the observation model.

14. The moving image decoding method according to claim 13, wherein the estimation processing estimates, using a convex projection method, pixel values X_{x,y}(t) of the original image of small defective region γₜ from an image given with the low-pass filter characteristics by the observation matrix.

15. The moving image decoding method according to claim 9, wherein the pre-processing calculates the second motion vectors (v=(vₓ, v_{y})) using a block matching method.

16. The moving image decoding method according to claim 9, wherein the pre-processing estimates pixel values Z_{x,y}(t) of the observation image of small defective region γₜ of the L×L pixels using a convex projection method.

17. A computer-readable medium storing a moving image decoding program that makes a computer execute moving image decoding processing, which receives a moving image signal which is compressed and encoded by prediction between frames which are motion-compensated for respective blocks each including M×M (M is a natural number greater than or equal to 2) pixels, and decodes an original moving image signal by sequentially repeating processing for detecting motion vectors for respective blocks from an image of a first frame in the moving image signal, and generating an image of a second frame which follows the first frame from motion-compensated prediction values corresponding to the motion vectors detected from the image of the first frame, the program making the computer execute:
matching processing for detecting a defective region Ψ which suffers a loss or an error from the image of the second frame, dividing defective region Ψ into a plurality of regions ωₜ each including N×N (N≦M) pixels as a unit, estimating first motion vectors (d=(dₓ, d_{y})) of the plurality of obtained divided defective regions ωₜ, estimating a plurality of regions ωₜ₋₁ in the image of the first frame, which correspond to the plurality of divided defective regions ωₜ in the image of the second frame, based on the first motion vectors, and interpolating the plurality of divided defective regions ωₜ in the image of the second frame by pixel values of the plurality of estimated regions ωₜ₋₁ in the image of the first frame;
pre-processing for calculating second motion vectors (v=(vₓ, v_{y})) of small defective regions γₜ each of which has each of the N×N pixels (x, y) as the center and includes L×L (L≦N) pixels in each divided defective region ωₜ of N×N pixels in the image of the second frame, estimating a plurality of small regions γₜ₋₁ each including L×L pixels in the image of the first frame, which respectively correspond to the plurality of small defective regions γₜ in the image of the second frame, based on the second motion vectors, and calculating a matrix A_{x,y}(t) used to estimate pixel values X_{x,y}(t) of original images of the plurality of small defective regions γₜ in the image of the second frame from pixel values X_{x+vx,y+vy}(t−1) of the plurality of small estimated regions γₜ₋₁ in the image of the first frame; and
estimation processing for estimating pixel values X_{x,y}(t) of the original image of each small defective region γₜ by estimating a covariance matrix Qᵥ(t) of an error vector, which is expressed by Z_{x,y}(t)−H_{x,y}(t)X_{x,y}(t), using a matrix H_{x,y}(t) which gives pixel values Z_{x,y}(t) of an observation image from pixel values X_{x,y}(t) of each small defective region γₜ including the L×L pixels.

18. The computer-readable medium storing a moving image decoding program according to claim 17, wherein the estimation processing estimates pixel values X_{x,y}(t) of the original image of small defective region γₜ using a state transition model that expresses changes between an image at a previous time and an image at a next time using motion vectors and an observation model that expresses correspondence between the original image and the observation image using an observation matrix, and using a Kalman filter algorithm that estimates an image for N×N pixels as a unit.

19. The computer-readable medium storing a moving image decoding program according to claim 18, wherein the estimation processing compensates for the motion vectors of the state transition model when a loss for respective blocks is generated.

20. The computer-readable medium storing a moving image decoding program according to claim 19, wherein the estimation processing uses a boundary matching algorithm in compensation of the motion vectors.

21. The computer-readable medium storing a moving image decoding program according to claim 18, wherein the estimation processing uses low-pass filter characteristics in the observation matrix of the observation model.

22. The computer-readable medium storing a moving image decoding program according to claim 21, wherein the estimation processing estimates, using a convex projection method, pixel values X_{x,y}(t) of the original image of small defective region γₜ from an image given with the low-pass filter characteristics by the observation matrix.

23. The computer-readable medium storing a moving image decoding program according to claim 17, wherein the pre-processing calculates the second motion vectors (v=(vₓ, v_{y})) using a block matching method.

24. The computer-readable medium storing a moving image decoding program according to claim 17, wherein the pre-processing estimates pixel values Z_{x,y}(t) of the observation image of small defective region γₜ of the L×L pixels using a convex projection method.
